(19) United States
(12) Patent Application Publication
(10) Pub. No.: US 2023/0025008 A1
(43) Pub. Date: Jan. 26, 2023

(54) A METHOD FOR CONTROLLING THE SIZE OF LITHIUM PEROXIDE AND A METHOD FOR PREPARING LITHIUM OXIDE WITH CONTROLLED SIZE

(71) Applicants: POSCO, Pohang-si, Gyeongsangbuk-do (KR); RESEARCH INSTITUTE OF INDUSTRIAL SCIENCE & TECHNOLOGY, Pohang-si, Gyeongsangbuk-do (KR)

(72) Inventors: Jae Myung LEE, Pohang-si (KR); Jun-Kyu AHN, Pohang-si (KR); Woo Chul JUNG, Pohang-si (KR); Kee Uek JEUNG, Pohang-si (KR); Jung Kwan PARK, Pohang-si (KR); Sang Won KIM, Pohang-si (KR)

(73) Assignees: POSCO, Pohang-si, Gyeongsangbuk-do (KR); RESEARCH INSTITUTE OF INDUSTRIAL SCIENCE & TECHNOLOGY, Pohang-si, Gyeongsangbuk-do (KR)

(21) Appl. No.: 17/787,010

(22) PCT Filed: Dec. 7, 2020
(86) PCT No.: PCT/KR2020/017783

§ 371 Date: Jun. 17, 2022

(30) Foreign Application Priority Data
Dec. 20, 2019 (KR) 10-2019-0172033

(51) Int. Cl. C01D 15/02; C01B 15/043

(52) U.S. Cl. CPC C01D 15/02; C01B 15/0435; C01P 2004/32; C01P 2004/61; C01P 2004/03; C01P 2002/72

(57) ABSTRACT

The present invention relates to a novel method for preparing lithium oxide. In the present invention, the particle size and shape of lithium oxide may be controlled during the preparing process. In addition, the present invention relates to lithium oxide with controlled particle size and shape prepared by this preparing method.

### BACKGROUND OF THE INVENTION

### (a) Field of the Invention

The present invention relates to a novel method for preparing lithium oxide. In the present invention, the particle size of lithium oxide may be controlled during the preparing method. In addition, the present invention relates to lithium oxide having a controlled particle size prepared by such a preparing method.

### (b) Description of the Related Art

Recently, expensive, high-purity lithium oxide (Li₂O) has been used as a raw material for the synthesis of over-lithiated transition metal oxide. Over-lithiated transition metal oxide is used as a positive electrode additive (or an over-discharge inhibitor) for improving an irreversible capacity of a lithium ion battery or as a highly reactive lithium raw material in a lithiation treatment for a negative electrode material. Overlithium metal oxide is synthesized by mixing the metal oxide and lithium oxide and then heat treatment in an inert atmosphere.

Conventionally, a number of methods for preparing lithium oxide are known. As an example, lithium oxide has been prepared by oxidizing metallic lithium by adjusting H₂O and CO₂ at a temperature of greater than or equal to 250° C. in a dry atmosphere. This method has the advantage that the reaction is fast, but there is a disadvantage that liquid Li is adsorbed to a reaction crucible, and a process of controlling H₂O and CO₂ in the reaction is required.

In the method of preparing lithium oxide by decomposing lithium hydroxide, lithium hydroxide is decomposed according to the following reaction scheme at a temperature of greater than or equal to 700° C. under vacuum or at a temperature of 200° C. to 300° C. under vacuum to obtain liquid lithium hydroxide, which is then decomposed again to obtain lithium oxide.

LiOH—H₂O(s)→LiOH(s),2LiOH(L)→Li₂O(s)+H₂O(g) or 2LiOH(s)→Li₂O(s)+H₂O(g)

When the reaction proceeds at a temperature of greater than or equal to 700° C., there is an advantage that the reaction is fast, but there is also a disadvantage that liquid Li is adsorbed in a reaction crucible and it is difficult to control CO₂ during the reaction. When the reaction proceeds at a temperature of 200° C. to 300° C., there is an advantage that a low reaction temperature is required, but there is a disadvantage that a high vacuum state is required for the reaction.

In the method of preparing lithium oxide by the lithium hydroxide wet conversion method, lithium peroxide has been obtained according to the following reaction scheme at room temperature, and then decomposed again to obtain lithium oxide.

2LiOH-xH₂O(s)→Li₂O₂(s);Li₂O₂(s)→Li₂O(s)+1/2O₂(g)

This method has the advantage that a low reaction temperature is required, but there is a disadvantage that reagents such as H₂O₂ and MeOH are required.

In the method of preparing lithium oxide by the lithium carbonate decomposition method, the reaction proceeds at a temperature of greater than or equal to 900° C. in a low PCO₂ atmosphere according to the reaction scheme Li₂CO₃(s)→Li₂O(s)+CO₂(g). The raw material cost is low but there is a disadvantage that the reaction rate is slow and a high temperature of greater than or equal to 1200° C. is required for practical use.

In the method of preparing lithium oxide by the lithium nitrate decomposition method, the reaction proceeds at a temperature of greater than or equal to 900° C. according to the reaction scheme 2LiNO₃(s)→Li₂O(s)+2NO₂(g)+1/2O₂(g). The reaction rate is fast but there is a disadvantage in that raw materials are expensive and a NOx removal process is involved.

Since the method of preparing lithium oxide from metallic lithium, the lithium hydroxide decomposition method, the lithium carbonate decomposition method, and the lithium nitrate decomposition method proceed at a temperature above melting points of the raw materials, lithium oxide is synthesized in a form of a large lump regardless of the particle size of the raw material powders. Therefore, in order to be used as raw materials for the synthesis of over-lithiated transition metal oxide, a process of pulverizing/classifying the produced lithium oxide lump as a subsequent process is required. In addition, loss of powder occurs in the pulverizing/classifying process for controlling the particle size, and there is a difficulty in shielding the atmosphere. Furthermore, it is very difficult to control the final particle size of the powder produced in this way.

### SUMMARY OF THE INVENTION

In order to improve a reaction yield in the synthesis reaction, the present inventors found that it is desirable that the lithium oxide has a spherical shape and a uniform particle size distribution, and that it is very important to control a ratio of average diameters of lithium oxide to metal oxide. In addition, for this purpose, a method of preparing lithium oxide capable of controlling a particle size of the lithium oxide produced has been developed.

In the present invention, a two-step lithium hydroxide wet conversion method is used to prepare lithium oxide. In the first step, lithium hydroxide is reacted with hydrogen peroxide water to synthesize Li₂O₂ as an intermediate material, and in the second step, the synthesized Li₂O₂ is decomposed at a high temperature in an inert atmosphere to convert it into lithium oxide (Li₂O).
1st step: 2LiOH-xH₂O+H₂O₂→Li₂O₂+yH₂O, x is an integer of 0 or more.
2nd step: Li₂O₂→Li₂O+1/2O₂(g)

In the second step, while the intermediate product Li₂O₂ is converted to Li₂O, the diameter of Li₂O₂ decreases by about 10% to 40%, but Li₂O having the same shape as the intermediate product is synthesized. Therefore, the size of the target diameter of the spherical Li₂O may be obtained by controlling the particle size of the Li₂O₂ intermediate material.

### BRIEF DESCRIPTION OF THE DRAWINGS

FIG. 1 is a flow chart of a two-step process of the present invention.

FIG. 2 is an SEM photograph of Li₂O₂ powder prepared according to the present invention.

FIG. 3 shows a graph of a relationship between the particle size of Li₂O₂ prepared according to the present invention and a linear velocity of the reactor.

FIG. 4 is a graph showing a relationship between the particle size of Li₂O₂ prepared according to the present invention and a linear velocity of the reactor.

FIG. 5 is a graph showing a relationship between the particle size of Li₂O₂ prepared according to the present invention and a linear velocity of the reactor.

FIG. 6 shows SEM photographs of Li₂O prepared according to the present invention.

FIG. 7 shows XRD results of Li₂O powder prepared according to the present invention.

FIG. 8 shows XRD results of Li₂O powder prepared according to the present invention.

FIG. 9 shows XRD results of Li₂O powder prepared according to the present invention.

FIG. 10 shows XRD results of Li₂O powder prepared according to the present invention.

FIG. 11 is a graph showing a relationship between the particle size of Li₂O prepared according to the present invention and a linear velocity of the reactor.

FIG. 12 is a graph showing a relationship between the particle size of Li₂O prepared according to the present invention and a linear velocity of the reactor.

FIG. 13 is a graph showing a relationship between the particle size of Li₂O prepared according to the present invention and a linear velocity of the reactor.

FIG. 14 shows SEM photographs of Li₂O powders prepared according to the present invention.

FIG. 15 shows SEM photographs of Li₂NiO₂ powders prepared according to the present invention.

FIG. 16 is a view illustrating a charge/discharge relationship of three coin cells manufactured according to the present invention.

### DETAILED DESCRIPTION OF THE EMBODIMENTS

In the present invention, lithium oxide is produced by a two-step lithium hydroxide wet conversion method. The lithium oxide of the present invention is produced by producing lithium peroxide in the first step and decomposing it with oxygen in the second step. The shapes of the resulting lithium oxide particles are the same as the shapes of the intermediate product, lithium peroxide particles, but the particle sizes thereof may be decreased to about 50% to 80%, desirably about 60% to 75%, and more desirably about 65% to 70%. Accordingly, by controlling the shapes, sizes, particle sizes, or diameters of the particles of lithium peroxide, desired shapes, sizes, particle sizes, or diameters of lithium oxide may be obtained.

In the first step, lithium hydroxide is dissociated in an aqueous solution to generate lithium ions, which react with hydrogen peroxide to synthesize lithium peroxide (Li₂O₂) and then precipitate it. When synthesizing lithium peroxide, it is possible to control the particle sizes of the generated lithium peroxide particles by controlling a collision rate and collision energy between the generated particles. The collision energy between particles varies depending on an internal shape of the reactor, a flow phenomenon of the reactants, and a moving speed of the solution, and as a leading variable, a tip velocity of the stirrer may be defined and controlled as follows.

Tip velocity: V_tip=2pi×R_impellor*(RPM)/60

The lithium oxide preparing process of the present invention includes a two-step reaction of the following lithium hydroxide raw material wet reaction and an inert atmosphere high-temperature decomposition reaction.
1st step: 2LiOH-xH₂O+H₂O₂→Li₂O₂+yH₂O, x is an integer of 0 or more.
2nd step: Li₂O₂→Li₂O+1/2O₂(g)

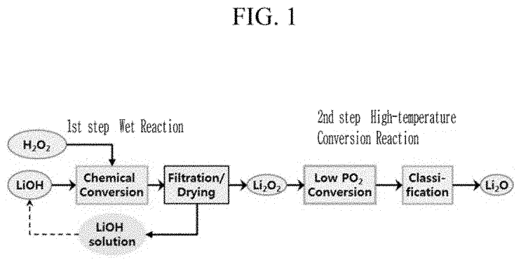

A flow chart of the two-step process of the present invention is shown in FIG. 1.

In each of the above steps, it is desirable to maintain an inert atmosphere in order to prevent contamination by moisture and CO₂ in the atmosphere and promote material conversion.

### 1) Step

### 1-1) Mixing of Raw Materials

In this step, a lithium raw material including lithium hydroxide monohydrate or lithium hydroxide and hydrogen peroxide water are mixed. A theoretical reaction ratio of lithium hydroxide and hydrogen peroxide water may be an equivalent ratio of lithium:hydrogen peroxide of 2:1, but the ratio may be controlled to improve a reaction yield. A desirable reaction equivalent ratio may be a ratio of lithium hydroxide to hydrogen peroxide of 4:1 to 1:1.

As a starting raw material, lithium hydroxide monohydrate (LiOH—H₂O), lithium hydroxide anhydride (LiOH), or lithium hydroxide polyhydrate (LiOH-xH₂O) may be used. In order to improve a reaction yield, it is desirable to use lithium hydroxide anhydride.

Hydrogen peroxide may be used as an aqueous solution (H₂O₂-zH₂O, z is an integer greater than or equal to 0). In order to improve a reaction yield, it is desirable to use pure hydrogen peroxide, but it is desirable to use an aqueous solution of 35% concentration in terms of storage and safety.

### 1-2) Precipitation of Intermediate Materials and Controlling Particle Size by Stirring the Reactor Impeller

By controlling the shape of the reactor, the shape and lengths (dimensions) of the internal baffles and impellers, the number of rotations of the impeller, and the reactor temperature, the particle size of the produced Li₂O₂ intermediate material may be controlled. In general, as the number of rotations of the impeller increases, the average size of the particles decreases and the shape is formed into particles that are close to a spherical shape.

As the reactor temperature becomes higher, the average particle size becomes larger, and the shape changes from spherical to amorphous. The lower the reactor temperature, the smaller the average particle size, and the shape changes from amorphous to a spherical shape.

The reaction time is 1 minute or more, desirably 30 minutes to 90 minutes after the raw materials are added. Although it is not necessary to adjust the temperature of the reactor, it is desirable to adjust it within the range of 30° C. to 60° C. in order to control the reaction rate.

When synthesizing lithium peroxide, it is possible to control the particle sizes of the generated lithium peroxide particles by controlling a collision rate and collision energy between the generated particles. The collision energy between particles varies depending on an internal shape of the reactor, a flow phenomenon of the reactants, and a moving speed of the solution, and as a leading variable, a tip velocity of the stirrer may be defined and controlled as follows.

Tip velocity: V_tip=2pi×R_impellor*(RPM)/60

In the above equation, pi means a circumference (3.141592 . . . ), R_impellor means a radius of the stirrer blade, and RPM means the number of revolutions per minute of the stirrer blade.

In the present invention, R_impellor is limited by the shape of the reactor and an operation range of the motor, and a person of ordinary skill in the art may determine the value in consideration of the motor specification according to the target tip velocity.

In the present invention, the tip velocity of the stirrer is 0.2 m/sec. to 20 m/sec., desirably 1 m/sec. to 10 m/sec.

In the present invention, the tip velocity is inversely proportional to the size of the generated particles, which means that the faster the tip velocity, the smaller the size of the particles.

### 1-3) Recovering and Drying of the Prepared Slurry Precipitate

An intermediate material slurry is prepared by stirring the impeller in the reactor. The prepared slurry may be separated into a solution and a solid by a method such as precipitation, passing through a filter, or centrifugation. The recovered solution is a lithium hydroxide aqueous solution in which an excess of lithium is dissolved, and may be used to prepare a lithium compound. The recovered Li₂O₂ solids may be dried by vacuum to dry the surface adsorbed water.

The Li₂O₂ particles prepared in the above step are close to or nearly spherical, or spherical. The particle size of the lithium peroxide produced is in the range of 1 μm to 130 μm, desirably in the range of 5 μm to 50 μm.

### 2) Step

### 2-1) Heat Treatment in Inert Atmosphere

The solid prepared in step 1) is Li₂O₂, which can be converted into Li₂O in an inert atmosphere or at a high temperature in a vacuum atmosphere. A conversion temperature is greater than or equal to 300° C., desirably 350° C. to 650° C. A conversion time (reaction time) depends on the conversion temperature (reaction temperature), and the conversion time and conversion temperature are inversely proportional. The inverse proportion between the conversion time and the conversion temperature means that the longer the conversion time in the same reaction, the lower the conversion temperature is. In an embodiment, the conversion time is greater than or equal to 10 minutes, desirably greater than or equal to 30 minutes, more desirably greater than or equal to 1 hour, even more specifically 30 minutes to 3 hours, or 1 hour to 2 hours. When the conversion temperature is 420° C., the conversion time is desirably greater than or equal to 30 minutes.

The particle shape of the produced lithium oxide is the same as the shape of the lithium peroxide particle, which is an intermediate product in step 1), but the particle size (particle size, diameter) is decreased into about 50% to 80%, desirably about 60% to 75%, and more desirably about 65% to 70%. The particle size of the lithium oxide produced in this step may be determined by the following equation:

(Lithium oxide particle size)=a×exp(b×Tip velocity),

wherein a and b are process constants

wherein, in the above equation, a and b are engineering constant values, 20<a<60, and −0.3<b<−0.1.

In the above equation, a is a parameter for explaining an effect of tip velocity on the particle size from an energy point of view, and increases as the number of collisions and energy increase at the same tip velocity. The a value may be a parameter of the number of baffles and the cross-sectional area of baffle which have an effect on the particle size, and the detailed value thereof may vary depending on various factors such as viscosity of the solution, particle size, and temperature. A person of ordinary skill in the art may determine the value of a within the above range in consideration of such process conditions.

The b value is a parameter that explains an influence of tip velocity on particle size in terms of particle pulverization and regrowth activation energy, and varies depending on particle defect energy and recrystallization energy relative to the same tip velocity. The detailed value may vary depending on various factors such as concentration of the solution, temperature, type of material, and content of impurities. A person of ordinary skill in the art may determine the b value within the above range in consideration of these process conditions.

### 2-2) Li₂O Powder Recovering and Packaging

The converted Li₂O may be filled with nitrogen and vacuum-packed to prevent denaturation in the atmosphere. In particular, when Li₂O comes into contact with moisture and CO₂ in the atmosphere at the same time, it may be denatured into lithium hydroxide and lithium carbonate, so care is required for storage.

The Li₂O particles prepared in the above step are close to or nearly spherical, or spherical. The particle size of lithium oxide is in the range of 1 μm to 100 μm, and desirably in the range of 5 μm to 50 μm.

Hereinafter, embodiments of the present invention will be described in more detail through the following examples. However, this is presented as the examples, and the present invention is not limited thereby, and the present invention is only defined by the scope of the claims to be described later.

### EXAMPLES

### Example 1

3 kg of reagent grade lithium hydroxide monohydrate (98%, Samjeon Chemical Co., Ltd.) and 3.4 kg of hydrogen peroxide water (34.5%, Samjeon Chemical Co., Ltd.) were mixed in the reactor. Four rectangular baffles were installed inside the reactor, and the reactor rotor was composed of a dual structure. Mechanical impeller was reacted for 1 hour while rotating at 150 to 750 rpm. About 1.2 kg of off-white slurry was collected and passed through a cone-type filter dryer equipped with a metal filter to separate solid and liquid. 1.7 kg of wet Li₂O₂ powder and 4.7 kg of aqueous solution were recovered. After storing the wet Li₂O₂ powders in a vacuum drying oven at 130° C. for 3 hours, 1.2 kg of the dried Li₂O₂ powders were recovered. As a result of XRD phase analysis, it was analyzed as 98.5% of Li₂O₂, 1.3% of Li₂CO₃, and 0.2% of LiOH—H₂O. Li₂CO₃ is estimated to be produced by CO₂ in the atmosphere during transport and XRD measurements.

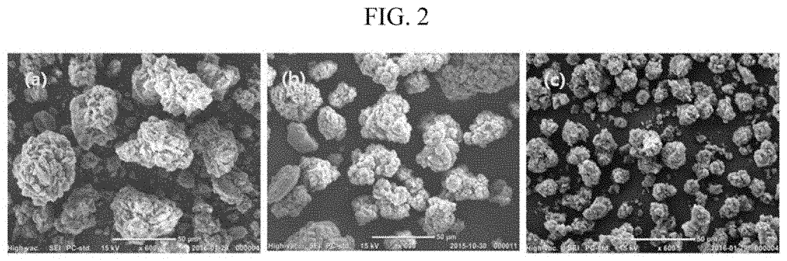

The SEM photographs of the recovered Li₂O₂ powders are shown in FIG. 2. As shown in FIG. 2, as the RPM increases, the size of the particles decreases.

The average particle size D50 was measured to be about 50±20 μm at 150 rpm, about 30±15 μm at 500 rpm, and about 20±10 μm at 750 rpm.

### Example 2

5.2 kg of reagent grade lithium hydroxide monohydrate (98%, Samjeon Chemical Co., Ltd.) and 6.0 kg of hydrogen peroxide water (34.5%, Samjeon Chemical Co., Ltd.) were mixed in the reactor. Four rectangular baffles were installed inside the reactor, and the reactor rotor was composed of a dual structure. The mixture was reacted by rotating a mechanical impeller at 150 rpm to 750 rpm for 1 hour. About 11.2 kg of off-white slurry was collected and passed through a cone-type filter dryer equipped with a metal filter to separate solid and liquid. 2.5 kg of wet Li₂O₂ powders and 8.7 kg of aqueous solution were recovered. After storing the wet Li₂O₂ powders in a vacuum drying oven at 130° C. for 3 hours, 2.1 kg of the dried Li₂O₂ powders were recovered. As a result of XRD phase analysis, it was analyzed as 98.5% of Li₂O₂, 1.3% of Li₂CO₃, and 0.2% of LiOH—H₂O.

The relationship between the particle size of Li₂O₂ prepared by the synthesis methods of Examples 1 and 2 and the linear velocity of the reactor during the synthesis reaction is summarized in the following table.

TABLE 1

| | LiOH—H2O | H₂O₂ | T. | H₂O₂ addition method and | |
|---|---|---|---|---|---|
| | (98.5%) | (34.5%) | velocity | reaction time | Li₂O₂ |
| rpm | [kg] | [kg] | [m/sec] | min | D50 [μm] |
| 150 | 3 | 3.4 | 0.982 | quantitative addition | 50 |
| | | | | (15 min) + (60 min reaction) | |
| 500 | 3 | 3.4 | 3.272 | quantitative addition | 30 |
| | | | | (15 min) + (60 min reaction) | |
| 750 | 3 | 3.4 | 4.909 | quantitative addition | 20 |
| | | | | (15 min) + (60 min reaction) | |
| 750 | 5.2 | 6 | 4.909 | quantitative addition | 25 |
| | | | | after 2 kg addition | |
| | | | | (15 min) + (60 min reaction) | |
| 750 | 5.2 | 6 | 4.909 | quantitative addition | 20 |
| | | | | (40 min) + (60 min reaction) | |

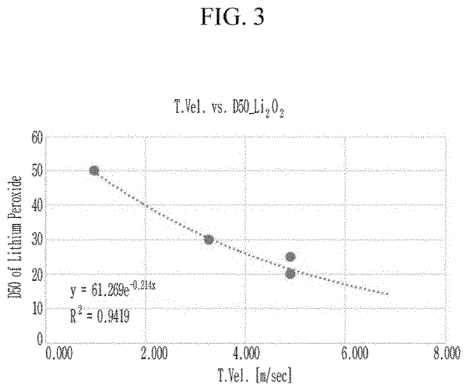

Based on the table, the relationship between the diameter of Li₂O₂ synthesized according to Examples 1 and 2 and the linear velocity of the reactor during the synthesis reaction is shown as a graph in FIG. 3.

### Example 3

30 kg of reagent grade lithium hydroxide monohydrate (98%, Samjeon Chemical Co., Ltd.) and 32 kg of hydrogen peroxide water (34.5%, Samjeon Chemical Co., Ltd.) were mixed in the reactor. Four rectangular baffles were installed inside the reactor, and the reactor rotor was composed of a dual structure. The mixture was reacted by rotating a mechanical impeller for 1 hour at 150 rpm to 500 rpm. About 12.7 kg of off-white slurry was collected and passed through a cone-type filter dryer equipped with a metal filter to separate solid and liquid. 14 kg of wet Li₂O₂ powder and 48 kg of aqueous solution were recovered. After storing the wet Li₂O₂ powders in a vacuum drying oven at 130° C. for 3 hours, 12.7 kg of the dried Li₂O₂ powders were recovered. As a result of XRD phase analysis, it was analyzed as 98.5% or greater of Li₂O₂.

The relationship between the particle size of Li₂O₂ prepared by the synthesis method of Example 3 and the linear velocity of the reactor during the synthesis reaction is summarized in the following table.

TABLE 2

| | LiOH—H₂O | H₂O₂ | T. | H₂O₂ addition method and | |
|---|---|---|---|---|---|
| | (98.5%) | (34.5%) | velocity | reaction time | Li₂O₂ |
| rpm | [kg] | [kg] | [m/sec] | min | D50 [μm] |
| 150 | 30 | 32 | 1.689 | quantitative addition | 40.3 |
| | | | | (5 min) + (60 min reaction), | |
| | | | | 40° C. | |
| 200 | 30 | 32 | 2.251 | quantitative addition | 32.1 |
| | | | | (5 min) + (60 min reaction), | |
| | | | | 40° C. | |
| 250 | 30 | 32 | 2.814 | quantitative addition | 28.9 |
| | | | | (5 min) + (60 min reaction), | |
| | | | | 40° C. | |
| 300 | 30 | 32 | 3.377 | quantitative addition | 27.2 |
| | | | | (5 min) + (60 min reaction), | |
| | | | | 40° C. | |
| 350 | 30 | 32 | 3.940 | quantitative addition | 22.7 |
| | | | | (5 min) + (60 min reaction), | |
| | | | | 40° C. | |
| 400 | 30 | 32 | 4.503 | quantitative addition | 19.5 |
| | | | | (5 min) + (60 min reaction), | |
| | | | | 40° C. | |
| 450 | 30 | 32 | 5.066 | quantitative addition | 19.5 |
| | | | | (5 min) + (60 min reaction), | |
| | | | | 40° C. | |
| 500 | 30 | 32 | 5.629 | quantitative addition | 14.9 |
| | | | | (5 min) + (60 min reaction), | |
| | | | | 40° C. | |
| 500 | 45 | 50 | 5.629 | quantitative addition | 17.0 |
| | | | | (5 min) + (60 min reaction), | |
| | | | | 40° C. | |
| 500 | 60 | 64 | 5.629 | quantitative addition | 17.2 |
| | | | | (5 min) + (60 min reaction), | |
| | | | | 40° C. | |
| 500 | 30 | 32 | 5.629 | quantitative addition | 15.3 |
| | | | | (5 min) + (60 min reaction), | |
| | | | | 50° C. | |
| 500 | 30 | 32 | 5.629 | quantitative addition | 15.8 |
| | | | | (5 min) + (60 min reaction), | |
| | | | | 30° C. | |

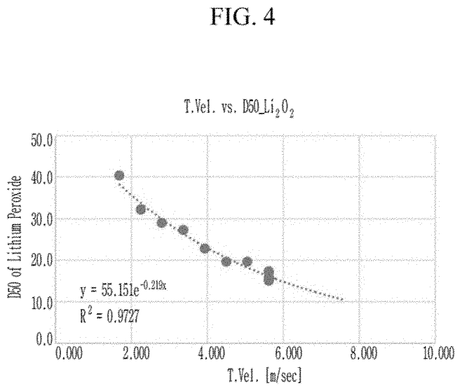

Based on the table, the relationship between the diameter of Li₂O₂ synthesized according to Example 3 and the linear velocity of the reactor during the synthesis reaction is shown as a graph in FIG. 4.

### Result Analysis of Example 1-3

As a data analysis result of Examples 1 to 3, regardless of a reactor size, the tip velocity and the average diameter (D50) of Li₂O₂ had the following relationship.

TABLE 3

| | LiOH—H₂O | H₂O₂ | T. | H₂O₂ addition method and | Li₂O₂ | Li₂O |
|---|---|---|---|---|---|---|
| | (98.5%) | (34.5%) | velocity | reaction time | D50 | D50 |
| rpm | [kg] | [kg] | [m/sec] | min | [μm] | [μm] |
| 150 | 3 | 3.4 | 0.981747704 | quantitative addition | 48.5 | 32.8 |
| | | | | (15 min) + (60 min reaction) | | |
| 500 | 3 | 3.4 | 3.272492347 | quantitative addition | 29.3 | 20.4 |
| | | | | (15 min) + (60 min reaction) | | |
| 750 | 3 | 3.4 | 4.908738521 | quantitative addition | 19.4 | 13.5 |
| | | | | (15 min) + (60 min reaction) | | |
| 750 | 5.2 | 6 | 4.908738521 | quantitative addition after 2 kg | 19.5 | 13.3 |
| | | | | addition (15 min) + (60 min | | |
| | | | | reaction | | |
| 750 | 5.2 | 6 | 4.908738521 | quantitative addition | 19.9 | 13.4 |
| | | | | (40 min) + (60 min reaction) | | |
| 150 | 30 | 32 | 1.688606051 | quantitative addition | 40.3 | 28.6 |
| | | | | (5 min) + (60 min reaction), | | |
| | | | | 40° C. | | |
| 200 | 30 | 32 | 2.251474735 | quantitative addition | 32.1 | 19.5 |
| | | | | (5 min) + (60 min reaction), | | |
| | | | | 40° C. | | |
| 250 | 30 | 32 | 2.814343419 | quantitative addition | 28.9 | 20.5 |
| | | | | (5 min) + (60 min reaction), | | |
| | | | | 40° C. | | |
| 300 | 30 | 32 | 3.377212103 | quantitative addition | 27.2 | 18.5 |
| | | | | (5 min) + (60 min reaction), | | |
| | | | | 40° C. | | |
| 350 | 30 | 32 | 3.940080786 | quantitative addition | 22.7 | 15.5 |
| | | | | (5 min) + (60 min reaction), | | |
| | | | | 40° C. | | |
| 400 | 30 | 32 | 4.50294947 | quantitative addition | 19.5 | 13.0 |
| | | | | (5 min) + (60 min reaction), | | |
| | | | | 40° C. | | |
| 450 | 30 | 32 | 5.065818154 | quantitative addition | 19.5 | 13.6 |
| | | | | (5 min) + (60 min reaction), | | |
| | | | | 40° C. | | |
| 500 | 30 | 32 | 5.628686838 | quantitative addition | 14.9 | 10.5 |
| | | | | (5 min) + (60 min reaction), | | |
| | | | | 40° C. | | |
| 500 | 45 | 50 | 5.628686838 | quantitative addition | 17.0 | 10.6 |
| | | | | (5 min) + (60 min reaction), | | |
| | | | | 40° C. | | |
| 500 | 60 | 64 | 5.628686838 | quantitative addition | 17.2 | 10.9 |
| | | | | (5 min) + (60 min reaction), | | |
| | | | | 40° C. | | |
| 500 | 30 | 32 | 5.628686838 | quantitative addition | 15.3 | 10.6 |
| | | | | (5 min) + (60 min reaction), | | |
| | | | | 50° C. | | |
| 500 | 30 | 32 | 5.628686838 | quantitative addition | 15.8 | 10.7 |
| | | | | (5 min) + (60 min reaction), | | |
| | | | | 30° C. | | |

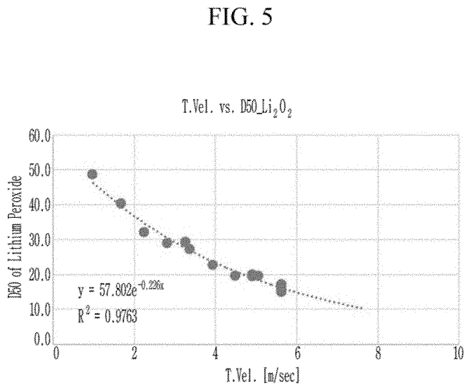

Based on the table, the relationship between the diameter of Li₂O₂ synthesized according to Example 3 and the linear velocity of the reactor during the synthesis reaction is shown as a graph in FIG. 5.

### Example 4: Conversion of Li₂O₂ to Li₂O

10 g of dried Li₂O₂ powders were put in an alumina crucible and then, exposed in a nitrogen atmosphere furnace at 425° C. for 7 hours. The powders were recovered to obtain 6.5 g of Li₂O.

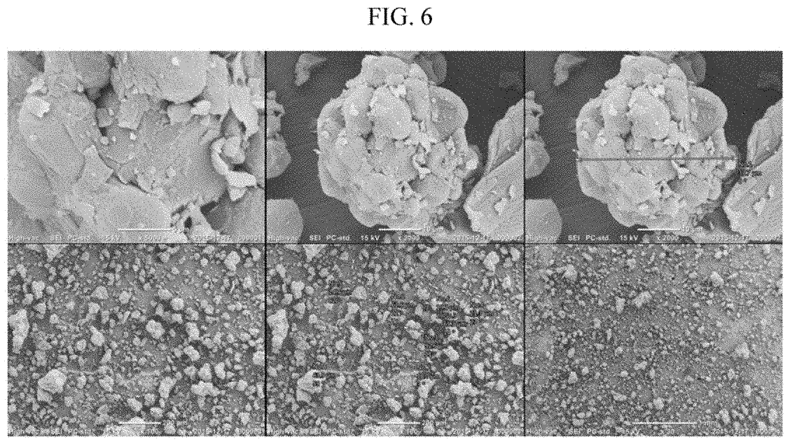

The obtained Li₂O was examined with respect to a shape by using SEM. FIG. 6 shows SEM images of the obtained Li₂O. The shape, as shown in FIG. 6, is spherical.

10 g of the dried Li₂O₂ powders were put in an alumina crucible and then, exposed in a nitrogen atmosphere furnace at 400° C. for 1 hour and 30 minutes and thus converted into Li₂O. 91.2% of Li₂O₂ in total was converted into Li₂O, and a portion of LiOH was found. The recovered Li₂O was 6.8 g.

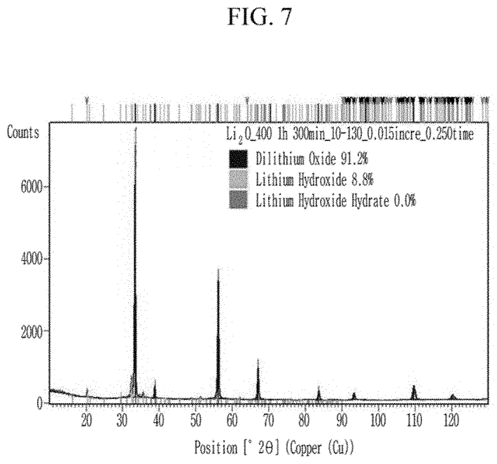

An XRD result of the recovered powders is shown in FIG. 7.

10 g of the dried Li₂O₂ powders were put in an alumina crucible and exposed in a nitrogen atmosphere furnace at 600° C. for 1 hour and 30 minutes and thus converted into Li₂O. The recovered Li₂O was 6.5 g.

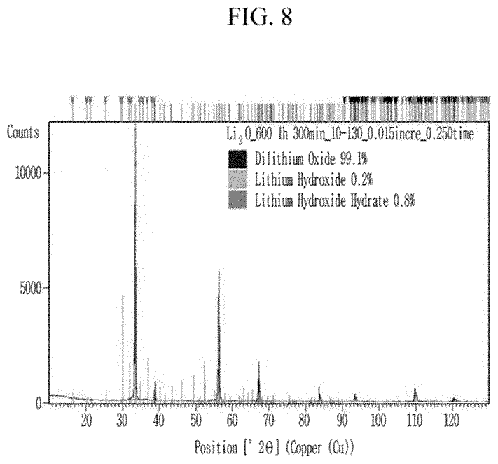

An XRD result of the obtained powder is shown in FIG. 8.

10 g of the dried Li₂O₂ powders were put in an alumina crucible and then, exposed at 700° C. in a nitrogen atmosphere furnace for 14 hours and thus converted into Li₂O. The recovered Li₂O was 6.5 g.

10 g of the dried Li₂O₂ powders were put in an alumina crucible and then, exposed in a nitrogen atmosphere furnace at 750° C. for 12 hours and thus converted into Li₂O. The recovered Li₂O was 6.5 g.

10 g of the dried Li₂O₂ powders was put in an alumina crucible and then, exposed in a nitrogen atmosphere furnace for 3 hours at 425° C. and then, at 950° C. for 1 hour and thus converted into Li₂O. The recovered Li₂O was 6.5 g.

10 g of the dried Li₂O₂ powders were put in an alumina crucible and then, exposed in a nitrogen atmosphere furnace at 425° C. for 3 hours and then, 950° C. for 2 hours and thus converted into Li₂O. The recovered Li₂O was 6.5 g.

500 g of the dried Li₂O₂ powders were put in an alumina crucible and then, exposed in a nitrogen atmosphere furnace at 425° C. for 3 hours to recover Li₂O. The recovered powders were 320 g.

10 g of the dried Li₂O₂ powders were put in an alumina crucible and then, exposed in an electric furnace at 600° C. for 1 hour 30 minutes to recover Li₂O. Oxygen with high purity (99.98%) 200 cc/min and nitrogen with high purity (99.98%) were supplied at 800 cc/min. The recovered powders were 6.5 g.

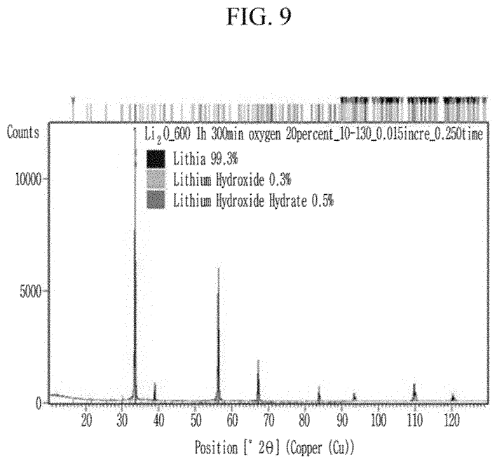

An XRD result of the prepared powder is shown in FIG. 9.

10 g of the dried Li₂O₂ powders were put in an alumina crucible and exposed in an electric furnace at 600° C. for 1 hour 30 minutes to recover Li₂O. Oxygen with high purity (99.98%) 200 cc/min and nitrogen with high purity (99.98%) were supplied at 800 cc/min. The recovered powders were 6.5 g.

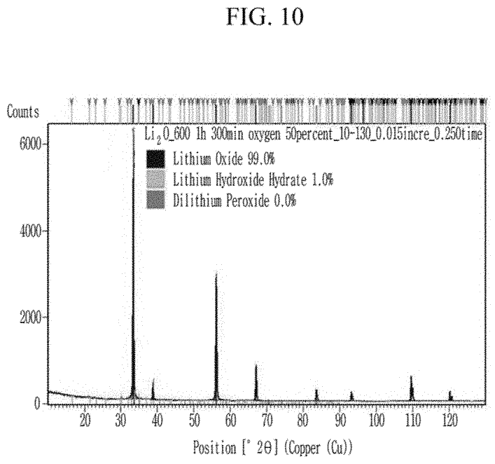

An XRD result of the prepared powder is shown in FIG. 10.

The relationship of the diameters of Li₂O₂ and Li₂O in Example 4 and the linear velocity of the reactor during the synthesis reaction is shown in Table 4.

TABLE 4

| | LiOH—H₂O | H₂O₂ | | H₂O₂ addition method and | Li₂O₂ | Li₂O |
|---|---|---|---|---|---|---|
| | (98.5%) | (34.5%) | T. velocity | reaction time | D50 | D50 |
| rpm | [kg] | [kg] | [m/sec] | min | [μm] | [μm] |
| 150 | 3 | 3.4 | 0.981747704 | quantitative addition | 48.5 | 32.8 |
| | | | | (15 min) + (60 min reaction) | | |
| 500 | 3 | 3.4 | 3.272492347 | quantitative addition | 29.3 | 20.4 |
| | | | | (15 min) + (60 min reaction) | | |
| 750 | 3 | 3.4 | 4.908738521 | quantitative addition | 19.4 | 13.5 |
| | | | | (15 min) + (60 min reaction) | | |
| 750 | 5.2 | 6 | 4.908738521 | quantitative addition after | 19.5 | 13.3 |
| | | | | 2 kg addition | | |
| | | | | (15 min) + (60 min reaction) | | |
| 750 | 5.2 | 6 | 4.908738521 | quantitative addition | 19.9 | 13.4 |
| | | | | (40 min) + (60 min reaction) | | |
| 150 | 30 | 32 | 1.688606051 | quantitative addition | 40.3 | 28.6 |
| | | | | (5 min) + (60 min reaction), | | |
| | | | | 40° C. | | |
| 200 | 30 | 32 | 2.251474735 | quantitative addition | 32.1 | 19.5 |
| | | | | (5 min) + (60 min reaction), | | |
| | | | | 40° C. | | |
| 250 | 30 | 32 | 2.814343419 | quantitative addition | 28.9 | 20.5 |
| | | | | (5 min) + (60 min reaction), | | |
| | | | | 40° C. | | |
| 300 | 30 | 32 | 3.377212103 | quantitative addition | 27.2 | 18.5 |
| | | | | (5 min) + (60 min reaction), | | |
| | | | | 40° C. | | |
| 350 | 30 | 32 | 3.940080786 | quantitative addition | 22.7 | 15.5 |
| | | | | (5 min) + (60 min reaction), | | |
| | | | | 40° C. | | |
| 400 | 30 | 32 | 4.50294947 | quantitative addition | 19.5 | 13.0 |
| | | | | (5 min) + (60 min reaction), | | |
| | | | | 40° C. | | |
| 450 | 30 | 32 | 5.065818154 | quantitative addition | 19.5 | 13.6 |
| | | | | (5 min) + (60 min reaction), | | |
| | | | | 40° C. | | |
| 500 | 30 | 32 | 5.628686838 | quantitative addition | 14.9 | 10.5 |
| | | | | (5 min) + (60 min reaction), | | |
| | | | | 40° C. | | |
| 500 | 45 | 50 | 5.628686838 | quantitative addition | 17.0 | 10.6 |
| | | | | (5 min) + (60 min reaction), | | |
| | | | | 40° C. | | |
| 500 | 60 | 64 | 5.628686838 | quantitative addition | 17.2 | 10.9 |
| | | | | (5 min) + (60 min reaction), | | |
| | | | | 40° C. | | |
| 500 | 30 | 32 | 5.628686838 | quantitative addition | 15.3 | 10.6 |
| | | | | (5 min) + (60 min reaction), | | |
| | | | | 50° C. | | |
| 500 | 30 | 32 | 5.628686838 | quantitative addition | 15.8 | 10.7 |
| | | | | (5 min) + (60 min reaction), | | |
| | | | | 30° C. | | |

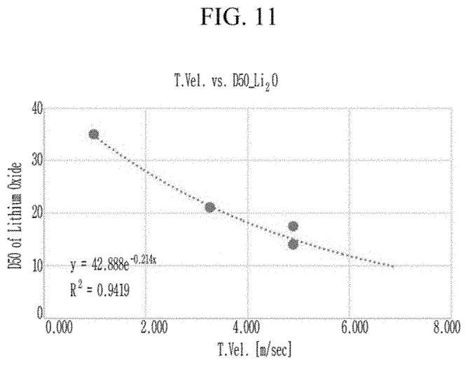

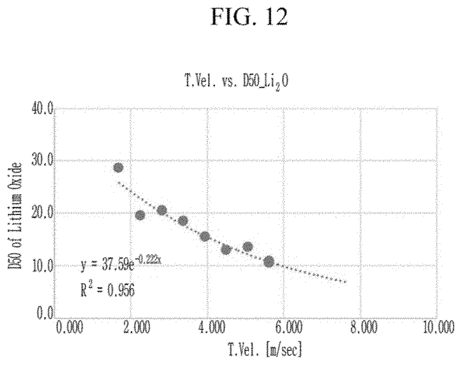

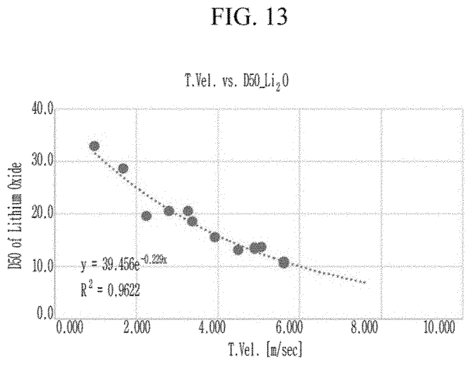

Based on the table, the relationship between the diameter of Li₂O and the linear velocity of the reactor during the synthesis reaction is shown as FIGS. 11 to 13. As aforementioned, since the tip velocity and the lithium oxide follow the following relationship equation, the tip velocity may be adjusted to control the diameter of the lithium oxide.

(Lithium oxide particle size)=a×exp(b×Tip velocity), wherein a and b are process constants

Herein, a and b are engineering constants and may be obtained as experimental values according to equipment.

### Example 5: Synthesis of Over-lithiated Transition Metal Oxide Using Li₂O as Raw Material

20 g of NiO and 8.85 g of the prepared Li₂O were mixed with a small blender for 5 minutes. The mixed powders were exposed in a nitrogen atmosphere furnace at 700° C. for 12 hours to synthesize Li₂NiO₂. The synthesized powders were 28.86 g.

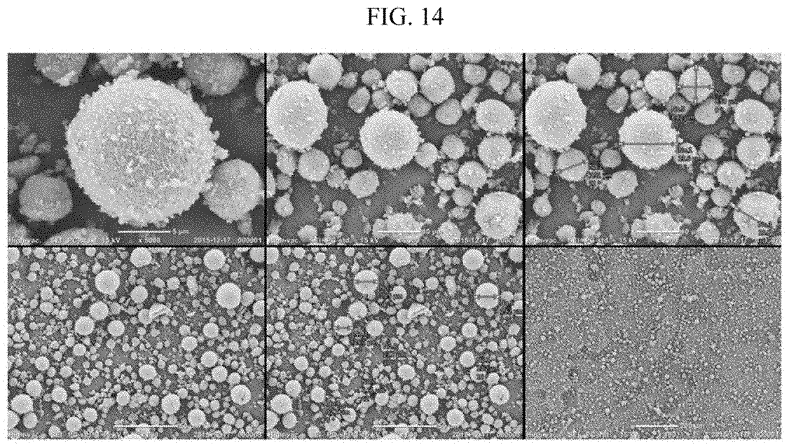

The mixture had a spherical shape, as shown in FIG. 14. Particularly, as shown in FIG. 14, pulverized Li₂O particulates were uniformly distributed on the surface of spherical NIO.

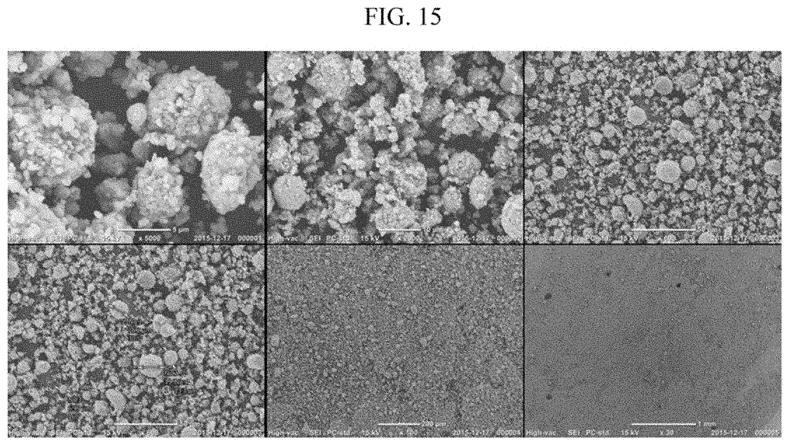

After a heat treatment at a high temperature, the synthesized Li₂NiO₂ had a shape as shown in FIG. 15. As shown in FIG. 15, spherical Li₂NiO₂ was formed, but non-reacted NiO and Li₂O were not found.

The prepared Li₂NiO₂ was used to manufacture a CR2032 coin cell, and electrochemical characteristics thereof were evaluated. An electrode was coated on a 14 mm-thick aluminum thin plate, and the coating layer had a thickness of 50 μm to 80 μm.

Electrode slurry was prepared by mixing Li₂NiO₂:denka black (D.B.):PvdF=85:10:5 wt %, and when an electrode manufactured by using the same was vacuum-dried and compressed, a thickness of a final coating layer was 40 μm to 60 μm. The electrolyte solution was an organic solution in which a 1M concentration of LiPF₆ salt was dissolved in a solvent (EC:EMC=1:2).

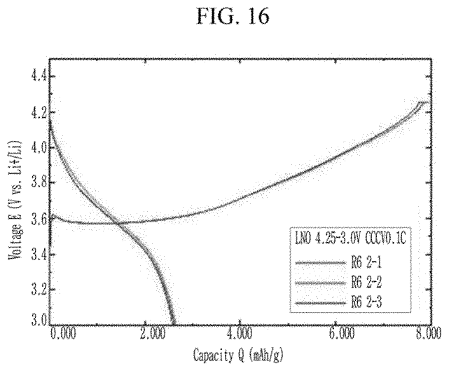

A manufactured coin cell was charged and discharged in a range of 4.25 V to 3.0 V at a 0.1 C-rate in a CC/CV mode under 1% condition. Charge and discharge curves of three coin cells are shown in FIG. 16.

The cells were three times tested with respect to charge/discharge, and each test showed the same result.

1 Red: as for average electrochemical characteristics of the coin cells, charge capacity of 389.88 mAh/g, discharge capacity of 130.99 mAh/g, irreversible capacity of 258.88 mAh/g, and reversible efficiency of 33.60% were obtained.

2 Green: as for average electrochemical characteristics of the coin cells, charge capacity of 388.19 mAh/g, discharge capacity of 130.82 mAh/g, irreversible capacity of 257.38 mAh/g, and reversible efficiency of 33.70% were obtained.

### Example 6

100 g of NiO and 41.2 g of Li₂O, a developed product, were mixed with a small blender for 10 minutes. The mixed powders were exposed in a nitrogen atmosphere furnace at 700° C. for 12 hours to synthesize Li₂NiO₂. The synthesized powders were recovered by 140 g.

100 g of NiO and 41.2 g of Li₂O purchased as a comparative material were mixed with a small mixer for 10 minutes. The mixed powders were exposed in a nitrogen atmosphere furnace at 700° C. for 12 hours to synthesize Li₂NiO₂. The synthesized powders were recovered by 140 g.

A particle size analysis result of the prepared powder is as follows: the developed product showed an increased diameter by 4.1 μm with a reference to D50, and Dmin and Dmax thereof were all increased. The reason is that the developed product promoted sintering effects during the LNO synthesis process.

TABLE 5

| Particle size analysis | Dmin | D50 | Dmax |
|---|---|---|---|
| result | [μm] | [μm] | [μm] |
| Comparative material | 4.47 | 13.23 | 39.23 |
| Developed product | 5.12 | 17.33 | 77.33 |
| Increment (Developed Product- | 0.65 | 4.1 | 0.65 |
| Comparative Material) | | | |
| Increment rate (Increment/ | 14.5% | 31.0% | 97.1% |
| Comparative Material) | | | |

When XRD was measured for a phase analysis of the prepared powder, the phase analysis results are shown in Table 6. As shown in the results, when the developed product was used, a LNO phase fraction was improved by 3.6 wt %, and a residual NiO content was reduced by 2.7 wt %.

TABLE 6

| XRD phase | LNO | NiO | Li₂O | |
|---|---|---|---|---|
| analysis result | (%) | (%) | (wt %) | Sum |
| Comparative | 90.9% | 7.6% | 1.5% | 100% |
| material | | | | |
| Developed product | 94.5% | 4.9% | 0.6% | 100% |
| Increment | 3.6% | −2.7% | −0.9% | 0.0% |
| (Developed Product- | | | | |
| Comparative | | | | |
| Material) | | | | |
| Increment rate | 3.9% | −35.8% | −57.0% | 0.0% |
| (Increment/ | | | | |
| Comparative | | | | |
| Material) | | | | |

A residual lithium amount of the prepared powders were measured in a neutralization titration method. The measured LiOH content was reduced by 58.2% from the developed product, as shown in Table 7. The Li₂CO₃ content was judged by denaturation according to an atmospheric exposure.

TABLE 7

| | LiOH | Li₂CO₃ |
|---|---|---|
| Residual lithium analysis | [wt %] | [wt %] |
| Comparative material | 4.19 | 0.36 |
| Developed product | 1.75 | 0.47 |
| Increment (Developed Product- | −2.44 | 0.11 |
| Comparative Material) | | |
| Increment rate (Increment/ | −58.2% | 30.6% |
| Comparative Material) | | |

The recovered powders were used as a raw material to manufacture a CR2032 coin cell, and electrochemical characteristics of the coin cells were evaluated. The prepared Li₂NiO₂ was pulverized with a mortar and then, passed through a mesh #325 to remove impurities and large particles. An electrode was coated on a 14 mm-thick aluminum thin plate. The coating layer had a thickness of 50 μm to 80 μm. Herein, electrode slurry was prepared by mixing Li₂NiO₂:denka black (D.B.):PvdF=85:10:5 wt %, and the manufactured electrode was vacuum-dried and compressed to obtain a final coating layer having a thickness of 40 μm to 60 μm. The electrolyte solution was an organic solution in which LiPF₆ salt was dissolved at a concentration of 1 M in a solvent (EC:EMC=1:2).

The manufactured coin cells were charged and discharged in a range of 4.25 V to 3.0 V at a 0.1C-rate in a CC/CV mode under a 1% condition.

As shown in the results, the developed product showed improvement effects of charge capacity of 2.7%, discharge capacity of 3.6%, and irreversible capacity of 2.2%. These results showed that a LNO synthesis rate was increased by the developed product having an improved reaction rate.

TABLE 8

| | CR2032 coin cell | | | |
|---|---|---|---|---|
| | Charge | Discharge | Irreversible | Reversible |
| Characteristic | capacity | capacity | capacity | efficiency |
| evaluation result | [mAh/g] | [mAh/g] | [mAh/g] | [%] |
| Developed product | 414.4 | 144.5 | 269.9 | 34.9% |
| Comparative material | 403.6 | 139.5 | 264.1 | 34.6% |
| Increment | 10.8 | 5 | 5.8 | 0.3% |
| (Developed Product- | | | | |
| Comparative | | | | |
| Material) | | | | |
| Increment rate | 2.7% | 3.6% | 2.2% | 0.9% |
| (Increment/ | | | | |
| Comparative | | | | |
| Material) | | | | |

As shown in the coin cell experiments, since a conversion rate was increased during the LNO synthesis, compared with the conventional Li₂O, there were effects of increasing electrochemical capacity, decreasing the residual lithium amount, and increasing material efficiency.

While this invention has been described in connection with what is presently considered to be practical example embodiments, it is to be understood that the invention is not limited to the disclosed embodiments. On the contrary, it is intended to cover various modifications and equivalent arrangements included within the spirit and scope of the appended claims.

What is claimed is:

1. A method of controlling a particle size of lithium peroxide,
wherein the lithium peroxide is produced by reacting lithium hydroxide hydrate with hydrogen peroxide in a reactor to prepare lithium peroxide,
a shape of the lithium peroxide is spherical,
the particle size is determined by adjusting a tip velocity of a stirrer in the reactor, and
the tip velocity is calculated by the equation:
V_tip=2pi×R_impellor*(RPM)/60
wherein, in the above equation, V-tip is a tip velocity, Pi is a circumference, R-impellor is a radius of the stirrer blade, and RPM is the number of revolutions per minute of the stirrer blade.

2. The method of claim 1, wherein the particle size of the prepared lithium peroxide is in the range of 1 μm to 130 μm.

3. The method of claim 1, wherein an equivalent ratio of lithium hydroxide hydrate to hydrogen peroxide is 4:1 to 1:1.

4. The method of claim 1, wherein a reaction temperature is in the range of 30° C. to 60° C. and a reaction time is 1 minute or more, or 30 minutes to 90 minutes.

5. A method of preparing a lithium peroxide having a controlled particle size, comprising
(1) reacting lithium hydroxide hydrate with hydrogen peroxide to prepare lithium peroxide; and
(2) decomposing the lithium peroxide at a high temperature under an inert atmosphere to prepare lithium oxide,
wherein in the (1) process, the particle size of lithium peroxide is determined by adjusting a tip velocity of a stirrer in a reactor, and
the tip velocity is calculated by the following equation:
V_tip=2pi×R_impellor*(RPM)/60
wherein, in the above equation, V-tip is a tip velocity, Pi is a circumference, R-impellor is a radius of the stirrer blade, and RPM is the number of revolutions per minute of the stirrer blade.

6. The method of claim 5, wherein
a particle size of lithium oxide prepared in the (2) process is determined by the following equation:
(lithium oxide particle size)=a×exp(b×V-tip), wherein a and b are process constants
wherein, in the above equation, a and b are engineering constant values, 20<a<60, and −0.3<b<−0.1.

7. The method of claim 5, wherein the particle size of lithium oxide prepared in the (2) process is 50 to 80%, or 60 to 70% of the particle size of lithium peroxide prepared in the (1) process.

8. The method of claim 5, wherein the particle size of lithium oxide produced in the (2) process is 60 to 70% of the particle size of lithium peroxide produced in the (1) process.

9. The method of claim 5, wherein in the (1) process, the tip velocity of the stirrer in the reactor is in the range of 0.2 m/sec. to 20 m/sec.

10. The method of claim 5, wherein the particle size of lithium oxide is in the range of 1 μm to 100 μm.

11. The method of claim 5, wherein the faster the tip velocity, the smaller the size of the produced particles.

12. The method of claim 5, wherein in the (2) process, a reaction temperature is greater than or equal to 300° C.

13. The method of claim 5, wherein a reaction time of the (2) process is greater than or equal to 10 minutes, or 30 minutes to 3 hours.
